(19) United States
(12) Patent Application Publication
(10) Pub. No.: US 2016/0162724 A1
(43) Pub. Date: Jun. 9, 2016

(54) FINGERPRINT IDENTIFICATION DEVICE AND METHOD FOR MANUFACTURING THEREOF

(71) Applicant: Key Application Technology Co., Ltd., Hsinchu County (TW)

(72) Inventors: Chien-Jen HSIAO, Hsinchu County (TW); Shih-Hsiu TSENG, Hsinchu City (TW)

(21) Appl. No.: 14/666,308

(22) Filed: Mar. 24, 2015

(30) Foreign Application Priority Data
Dec. 3, 2014 (TW) 103142041

(51) Int. Cl. G06K 9/00

(52) U.S. Cl. CPC G06K 9/00087; G06K 9/0002; G06K 9/00053

(57) ABSTRACT

The present disclosure provides a fingerprint identification device including a substrate, a sensitive die, a packaging material layer and a protection film. The sensitive die is positioned on the substrate, and has a top surface. The packaging material layer is positioned on the substrate, surrounding the sensitive die and exposing the top surface of the sensitive die, wherein a top surface of the packaging material layer and the top surface of the sensitive die have a coplanar. The protection film covers the sensitive die and the packaging material layer, wherein a material of the protection film is different from that of the packaging material layer. A method for manufacturing a fingerprint identification device is also provided herein.

### BACKGROUND

This application claims priority to Taiwan Application Serial Number 103142041, filed Dec. 3, 2014, which is incorporated herein by reference.

1. Field of Invention

The present disclosure relates to a fingerprint identification device. More particularly, the present disclosure relates to a fingerprint identification device having a glue layer and a method for manufacturing thereof.

2. Description of Related Art

Generally, a typical method for manufacturing a fingerprint identification device includes the following steps. An identification chip is first disposed on a substrate, and then the identification chip and the substrate are covered by an insulation packaging material. By a polishing process, a part of the insulating packaging material on the identification chip is polished, and a color pattern layer and an optical hard coat are sequentially adhered on the insulation packaging material. After performing the above manufacturing method, a fingerprint identification device is obtained, which the device includes, from bottom to top, the substrate, the identification chip, the insulation packaging material, the color pattern layer and the optical hard coat.

However, when the insulation packaging material is polished during the polishing process of the manufacturing method, the removed amount and the residual thickness of the insulation packaging material can not be precisely controlled, so that the packaged fingerprint identification device has a significant tolerance in thickness. Furthermore, if the entire thickness of the fingerprint identification device is too thick or too thin, the fingerprint identification device will be unable to fit in a desired electronic device, which makes the fingerprint identification device have poor applicability.

Accordingly, there is a need for an improved fingerprint identification device and a manufacturing method thereof to solve the aforementioned problems met in the art.

### SUMMARY

In view of the problems in the art, a fingerprint identification device provided by the present disclosure may solve that a conventional packaged fingerprint identification device has a significant tolerance of thickness and is difficult to be applied.

An embodiment of the present disclosure is provided a fingerprint identification device including a substrate, a sensor chip, a glue layer and a protection film.

The sensor chip, having a top surface, is disposed on the substrate. The glue layer is disposed on the substrate, and surrounds the sensor chip and exposes the top surface of the sensor chip. The top surface of the glue layer is coplanar with the top surface of the sensor chip. The protection film covers the sensor chip and the glue layer, and a material of the protection film is different from a material of the glue layer.

According to various embodiments of the present disclosure, the substrate includes a circuit board or an insulating substrate.

According to various embodiments of the present disclosure, the sensor chip is electrically connected to the circuit board.

According to various embodiments of the present disclosure, the fingerprint identification device further includes a first adhesion layer sandwiched between the sensor chip and the substrate.

According to various embodiments of the present disclosure, the sensor chip includes a fingerprint identified chip.

According to various embodiments of the present disclosure, a material of the glue layer includes an insulating composite.

According to various embodiments of the present disclosure, the insulating composite includes an epoxy resin.

According to various embodiments of the present disclosure, the protection film includes a color-coating layer and an optical anti-wear layer. According to various embodiments of the present disclosure, the color-coating layer covers the sensor chip and the glue layer; and the optical anti-wear layer covers the color-coating layer.

According to various embodiments of the present disclosure, the optical anti-wear layer includes an optical hard coat layer or an optical glass layer.

According to various embodiments of the present disclosure, the protection film includes a second adhesive layer sandwiched between the color-coating layer and the sensor chip and between the color-coating layer and the glue layer.

According to various embodiments of the present disclosure, a thickness of the protection film is in a range of 20-50 μm.

Another embodiment of the present disclosure is provided a method for manufacturing a fingerprint identification device. The method includes the following operations. A sensor chip is formed on a substrate. A glue layer is formed on the substrate, surrounds the sensor chip and exposes a top surface of the sensor chip. A top surface of the glue layer and the top surface of the sensor board are formed a flat surface. A protection film is formed on the sensor hip and the glue layer.

According to various embodiments of the present disclosure, the method further includes forming a first adhesion layer between the sensor chip and the substrate.

According to various embodiments of the present disclosure, the operation of forming the protection film includes forming a color-coating layer on the sensor chip and the glue layer; and forming an optical anti-wear layer covering the color-coating layer.

According to various embodiments of the present disclosure, the operation of forming the optical anti-wear layer includes forming an optical hard coat layer or forming an optical glass layer.

According to various embodiments of the present disclosure, the operation of forming the protection film further includes forming a second adhesion layer between the color-coating layer and the sensor chip and between the-color-coating layer and the glue layer.

It is to be understood that both the foregoing general description and the following detailed description are by examples, and are intended to provide further explanation of the present disclosure as claimed.

### BRIEF DESCRIPTION OF THE DRAWINGS

The present disclosure can be more fully understood by reading the following detailed description of the embodiment, with reference made to the accompanying drawings as follows:

FIG. 1 is a schematic cross-sectional view of a fingerprint identification device 100 according to various embodiments of the present disclosure.

FIG. 2 is a schematic cross-sectional view of a fingerprint identification device 200 according to various embodiments of the present disclosure.

FIG. 3 is a schematic cross-sectional view of a fingerprint identification device 300 according to various embodiments of the present disclosure.

FIG. 4 is a schematic cross-sectional view of a fingerprint identification device 400 according to various embodiments of the present disclosure.

FIGS. 5A-5C are schematic cross-sectional views at various stages of fabricating a fingerprint identification device 500 according various embodiments of the present disclosure.

FIG. 6 is a schematic cross-sectional view at a stage of fabricating a fingerprint identification device 600 according various embodiments of the present disclosure.

FIGS. 7A-7B are schematic cross-sectional views at various stages of fabricating a fingerprint identification device 700 according various embodiments of the present disclosure.

FIG. 8 is a schematic cross-sectional view at a stage of fabricating a fingerprint identification device 800 according various embodiments of the present disclosure.

FIG. 9 is a flow chart illustrating a method for manufacturing a fingerprint identification device according various embodiments of the present disclosure.

### DETAILED DESCRIPTION

The singular forms “a”, “an” and “the” used herein include plural referents unless the context clearly dictates otherwise. Therefore, reference to, for example, a metal layer includes embodiments having two or more such metal layers, unless the context clearly indicates otherwise. Reference throughout this specification to “one embodiment” means that a particular feature, structure, or characteristic described in connection with the embodiment is included in at least one embodiment of the present disclosure. Therefore, the appearances of the phrases “in one embodiment” or “in an embodiment” in various places throughout this specification are not necessarily all referring to the same embodiment. Further, the particular features, structures, or characteristics may be combined in any suitable manner in one or more embodiments. It should be appreciated that the following figures are not drawn to scale; rather, the figures are intended; rather, these figures are intended for illustration.

In view of the problems in the art, a fingerprint identification device provided by the present disclosure may solve that a conventional packaged fingerprint identification device has a significant tolerance of thickness and is difficult to be applied.

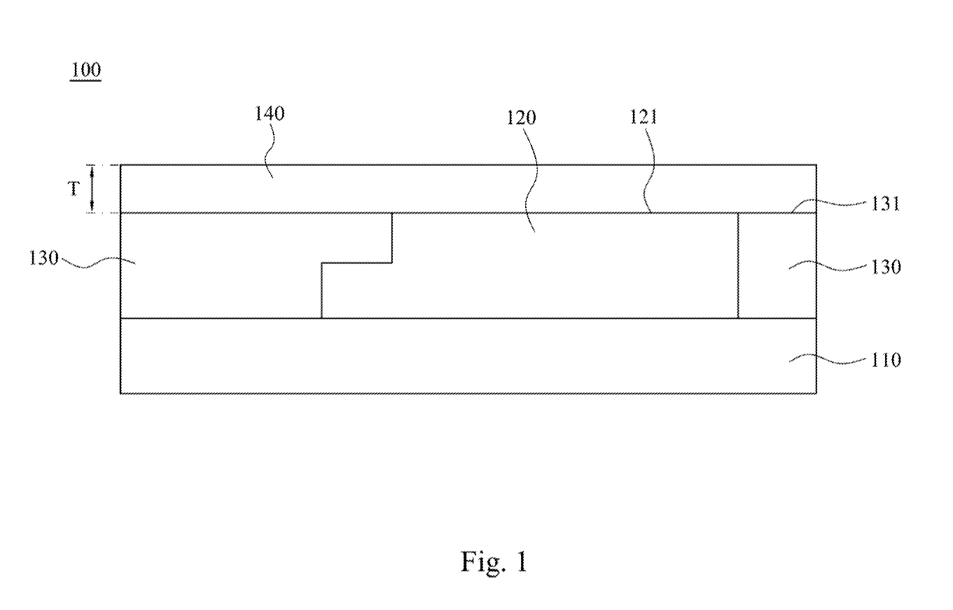

FIG. 1 is a schematic cross-sectional view of a fingerprint identification device 100 according to various embodiments of the present disclosure. In FIG. 1, the fingerprint identification device 100 includes a substrate 110, a sensor chip 120, a glue layer 130 and a protection film 140.

The sensor chip 120, having a top surface 121, is disposed on the substrate 110. According to various embodiments of the present disclosure, the substrate 110 includes a circuit board or an insulating substrate. According to various embodiments of the present disclosure, the sensor chip 120 is electrically connected to the circuit board. According to various embodiments of the present disclosure, the sensor chip 120 includes a fingerprint identified chip.

The glue layer 130 is disposed on the substrate 110, and surrounds the sensor chip 120 and exposes the top surface 121 of the sensor chip 120. According to various embodiments of the present disclosure, the top surface 131 of the glue layer 130 is coplanar with the top surface 121 of the sensor chip 120. According to various embodiments of the present disclosure, a material of the glue layer 130 includes an insulating composite. According to various embodiments of the present disclosure, the insulating composite includes an epoxy resin.

The protection film 140 covers the sensor chip 120 and the glue layer 130, and a material of the protection film 140 is different from a material of the glue layer 130 According to various embodiments of the present disclosure, the protection film 140 includes an optical hard coat layer. According to various embodiments of the present disclosure, a thickness (T) of the protection film 140 is in a range of 20-50 μm.

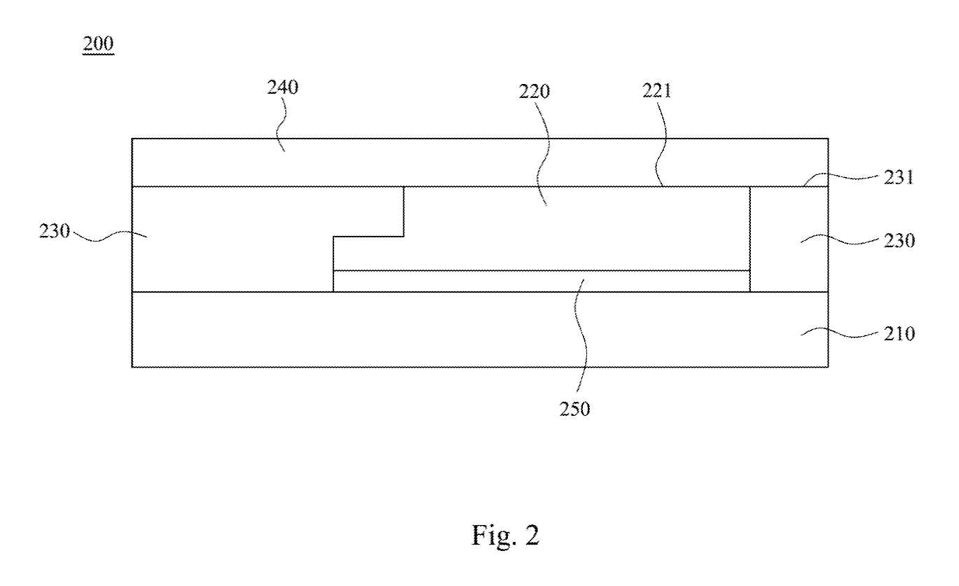

FIG. 2 is a schematic cross-sectional view of a fingerprint identification device 200 according to various embodiments of the present disclosure. In FIG. 2, the fingerprint identification device 200 includes a substrate 210, a sensor chip 220, a glue layer 230, a protection film 240 and an adhesion layer 250.

The sensor chip 220, having a top surface 221, is disposed on the substrate 210. According to various embodiments of the present disclosure, the substrate 210 includes a circuit board or an insulating substrate. According to various embodiments of the present disclosure, the sensor chip 220 is electrically connected to the circuit board. According to various embodiments of the present disclosure, the sensor chip 220 includes a fingerprint identified chip.

Different from the fingerprint identification device 100 of FIG. 1, in FIG. 2, the fingerprint identification device 200 further includes the adhesion layer 250 sandwiched between the substrate 210 and the sensor chip 220.

The glue layer 230 is disposed on the substrate 210, and surrounds the sensor chip 220 and exposes the top surface 221 of the sensor chip 220.

According to various embodiments of the present disclosure, a top surface 231 of the glue layer 230 is coplanar with the top surface 221 of the sensor chip 220. According to various embodiments of the present disclosure, a material of the glue layer 230 includes an insulating composite. According to various embodiments of the present disclosure, the insulating composite includes an epoxy resin.

The protection film 240 covers the sensor chip 220 and the glue layer 230, and a material of the protection film 240 is different from a material of the glue layer 230. According to various embodiments of the present disclosure, the protection film 240 includes an optical hard coat layer.

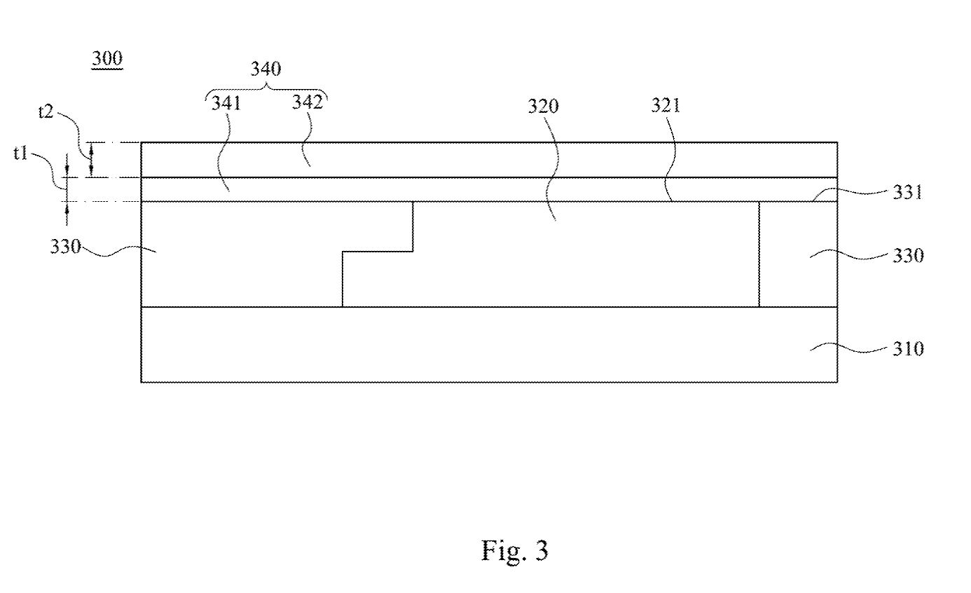

FIG. 3 is a schematic cross-sectional view of a fingerprint identification device 300 according to various embodiments of the present disclosure. In FIG. 3, the fingerprint identification device 300 includes a substrate 310, a sensor chip 320, a glue layer 330 and a protection film 340.

The sensor chip 320, having a top surface 321, is disposed on the substrate 310. According to various embodiments of the present disclosure, the substrate 310 includes a circuit board or an insulating substrate. According to various embodiments of the present disclosure, the sensor chip 320 is electrically connected to the circuit board. According to various embodiments of the present disclosure, the sensor chip 320 includes a fingerprint identified chip.

The glue layer 330 is disposed on the substrate 310, and surrounds the sensor chip 320 and exposes the top surface 321 of the sensor chip 320. According to various embodiments of the present disclosure, a top surface 331 of the glue layer 330 is coplanar with the top surface 321 of the sensor chip 320. According to various embodiments of the present disclosure, a material of the glue layer 330 includes an insulating composite. According to various embodiments of the present disclosure, the insulating composite includes an epoxy resin.

The protection film 340 covers the sensor chip 320 and the glue layer 330, and a material of the protection film 340 is different from a material of the glue layer 330. According to various embodiments of the present disclosure, the protection film 340 includes a color-coating layer 341 and an optical anti-wear layer 342.

In FIG. 3, the color-coating layer 341 covers the sensor chip 320 and the glue layer 330; and the optical anti-wear layer 342 covers the color-coating layer 341. According to various embodiments of the present disclosure, the color-coating layer 341 includes a color resin layer. According to various embodiments of the present disclosure, the color-coating layer 341 has a color pattern including black, white, other colors or a combination thereof. According to various embodiments of the present disclosure, a thickness (t1) of the color-coating layer 341 is in a range of 5-30 μm. According to various embodiments of the present disclosure, the optical anti-wear layer 342 includes an optical hard coat layer or an optical glass layer. According to various embodiments of the present disclosure, a hardness of the optical anti-wear layer 342 is in a range of 5 H-9 H. According to various embodiments of the present disclosure, a thickness (t2) of the optical anti-wear layer 342 is in a range of 15-40 μm.

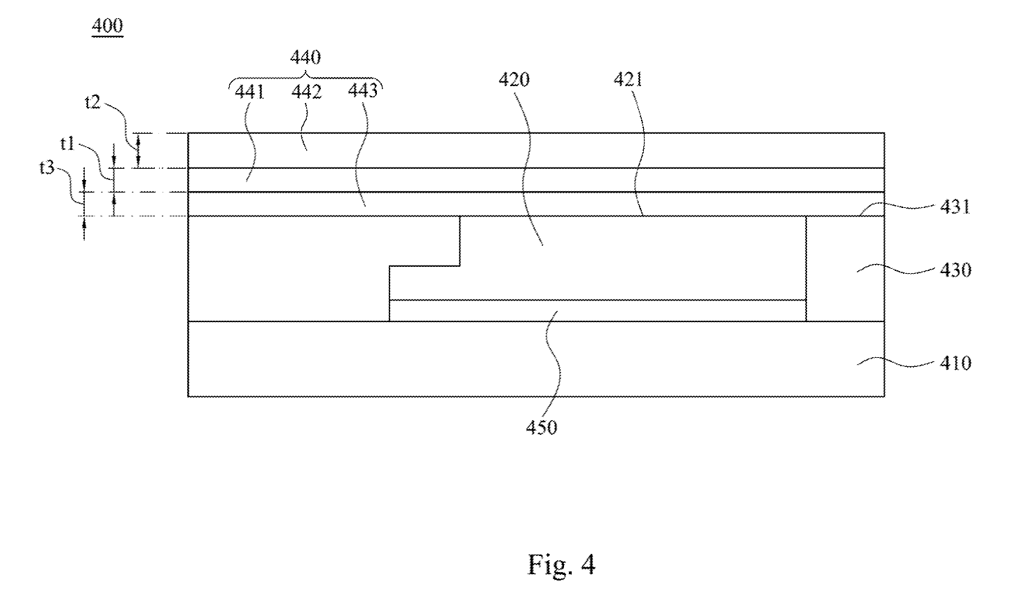

FIG. 4 is a schematic cross-sectional view of a fingerprint identification device 400 according to various embodiments of the present disclosure. In FIG. 4, the fingerprint identification device 400 includes a substrate 410, a sensor chip 420, a glue layer 430, a protection film 440 and a first, adhesion layer 450.

The sensor chip 420, having a top surface 421 is disposed on the substrate 410. According to various embodiments of the present disclosure, the substrate 410 includes a circuit board or an insulating substrate. According to various embodiments of the present disclosure, the sensor chip 420 is electrically connected to the circuit board. According to various embodiments of the present disclosure, the sensor chip 420 includes a fingerprint identified chip.

Different from the fingerprint identification device 300 of FIG. 3, in FIG. 4, the fingerprint identification device 400 further includes the first adhesion layer 450 sandwiched between the substrate 410 and the sensor chip 420.

The glue layer 430 is disposed on the substrate 410, and surrounds the sensor chip 420 and exposes the top surface 421 of the sensor chip 420. According to various embodiments of the present disclosure, a top surface 431 of the glue layer 430 is coplanar with the top surface 421 of the sensor chip 420. According to various embodiments of the present disclosure, a material of the glue layer 430 includes an insulating composite. According to various embodiments of the present disclosure, the insulating composite includes an epoxy resin.

The protection film 440 covers the sensor chip 420 and the glue layer 430, and a material of the protection film 440 is different from a material of the glue layer 430. According to various embodiments of the present disclosure, the protection film 440 includes a color-coating layer 441 and an optical anti-wear layer 442.

In FIG. 4, the color-coating layer 441 covers the sensor chip 420 and the glue layer 430; and the optical anti-wear layer 442 covers the color-coating layer 441. According to various embodiments of the present disclosure, the color-coating layer 441 includes a color resin layer. According to various embodiments of the present disclosure, the color-coating layer 441 has a color pattern including black, white, other colors or a combination thereof. According to various embodiments of the present disclosure, a thickness (t1) of the color-coating layer 441 is in a range of 5-30 μm. According to various embodiments of the present disclosure, the optical anti-wear layer 442 includes an optical hard coat layer or an optical glass layer. According to various embodiments of the present disclosure, a hardness of the optical anti-wear layer 442 is in a range of 5 H-9 H. According to various embodiments of the present disclosure, a thickness (t2) of the optical anti-wear layer 442 is in a range of 15-40 μm.

Different from the fingerprint identification device 300 of FIG. 3, in FIG. 4, the fingerprint identification device 400 further includes a second adhesion layer 4430 sandwiched between the color-coating layer 441 and the sensor chip 420 and between the color-coating layer 441 and the glue layer 430. According to various embodiments of the present disclosure, a thickness (t3) of the second adhesion layer 443 is in a range of 2-10 μm.

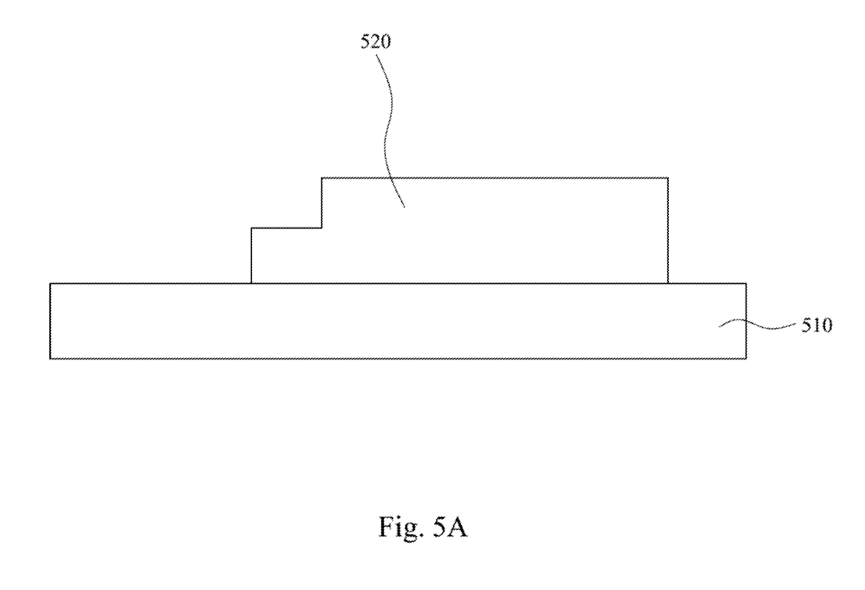

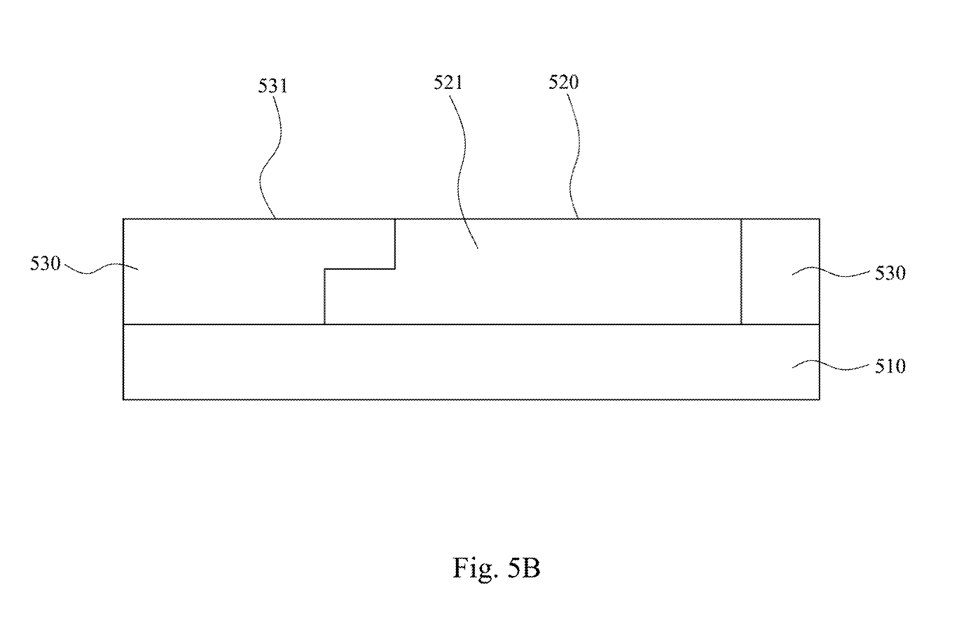

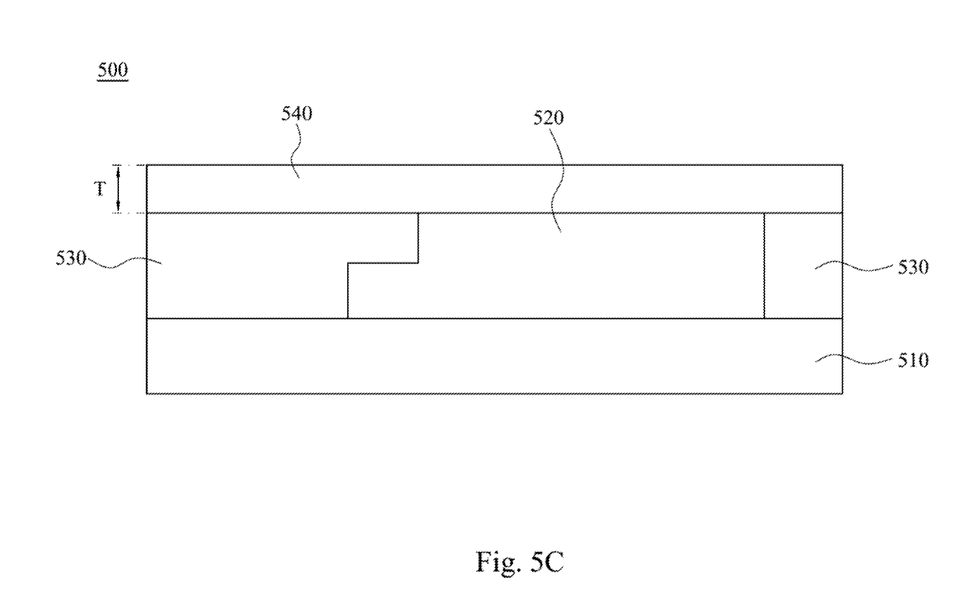

FIGS. 5A-5C are schematic cross-sectional views at various stages of fabricating a fingerprint identification device 500 according various embodiments of the present disclosure.

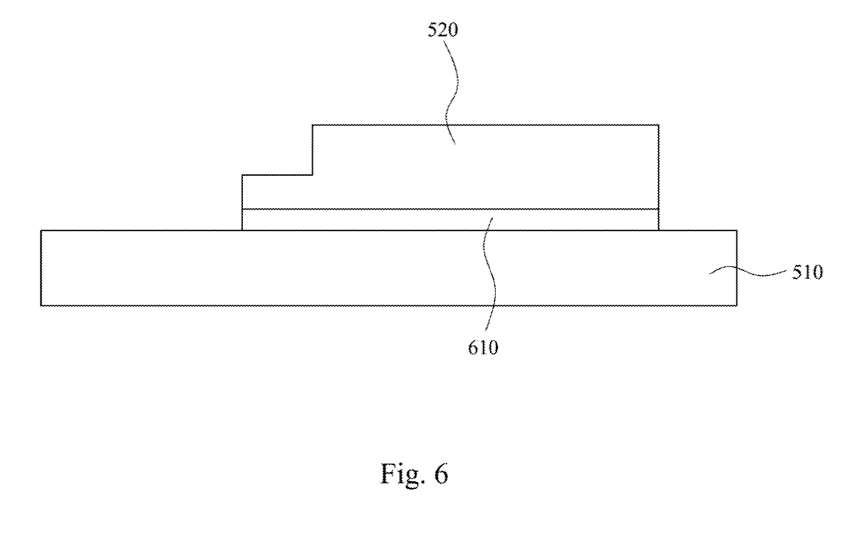

In FIG. 5A, a sensor chip 520 is formed on a substrate 510. According to various embodiments of the present disclosure, the substrate 510 includes a circuit board or an insulating substrate. According to various embodiments of the present disclosure, the sensor chip 520 is electrically connected to the circuit board. According to various embodiments of the present disclosure, the sensor chip 520 includes a fingerprint identified chip. According to various embodiments of the present disclosure a first adhesion layer 610 is further formed between the sensor chip 520 and the substrate 510, as shown in FIG. 6.

In FIG. 5B, a glue layer 530 is formed on the substrate 510. The glue layer 530 surrounds the sensor chip 520 and exposes a top surface 521 of the sensor chip 520. According to various embodiments of the present disclosure, a top surface 531 of the glue layer 530 and the top surface 521 of the sensor board 520 are formed a flat surface. According to various embodiments of the present disclosure, a material of the glue layer 530 includes an insulating composite. According to various embodiments of the present disclosure, the insulating composite includes an epoxy resin.

In FIG. 5C, a protection film 540 is formed on the sensor chip 520 and the glue layer 530. According to various embodiments of the present disclosure, a material of the protection film 540 is different from a material of the glue layer 530. According to various embodiments of the present disclosure, the protection film 540 includes an optical hard coat layer. According to various embodiments of the present disclosure, a thickness (T) of the protection film 540 is in a range of 20-50 μm.

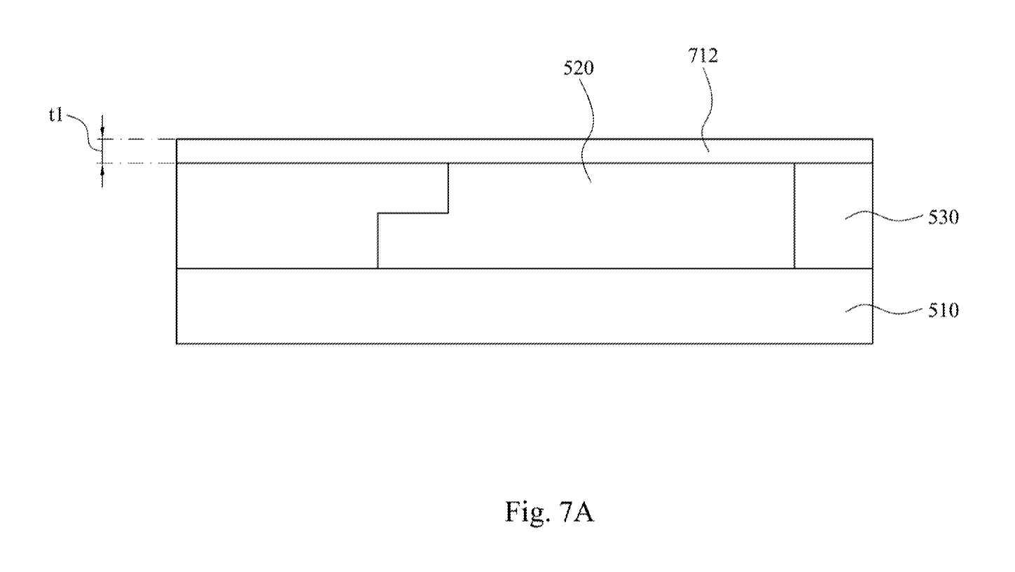

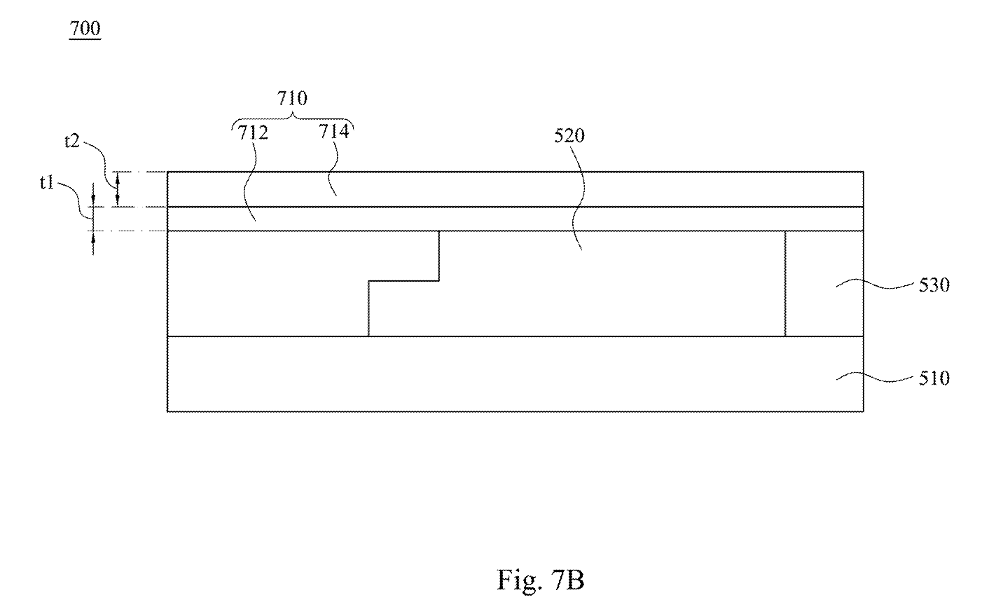

FIGS. 7A-7B are schematic cross-sectional views at various stages of fabricating a fingerprint identification device 700 according various embodiments of the present disclosure. FIGS. 7A and 7B are followed FIG. 5B. In FIGS. 7A and 7B, the operation of forming a protection film 710 includes forming a color-coating layer 712 and forming an optical anti-wear layer 714.

Regarding to FIG. 7A, the color-coating layer 712 is formed on the sensor chip 520 and the glue layer 530. According to various embodiments of the present disclosure, the color-coating layer 712 includes a color resin layer. According to various embodiments of the present disclosure, the color-coating layer 712 has a color pattern including black, white, other colors or a combination thereof. According to various embodiments of the present disclosure, thickness (t1) of the color-coating layer 712 is in a range of 5-30 μm.

Regarding to FIG. 7B, the optical anti-wear layer 714 covers the color-coating layer 712. According to various embodiments of the present disclosure, the optical an wear layer 714 includes an optical hard coat layer or an optical glass layer. According to various embodiments of the present disclosure, a hardness of the optical anti-wear layer 714 is in a range of 5 H-9 H. According to various embodiments of the present disclosure, a thickness (t2) of the optical anti-wear layer 714 is in a range of 15-40 μm.

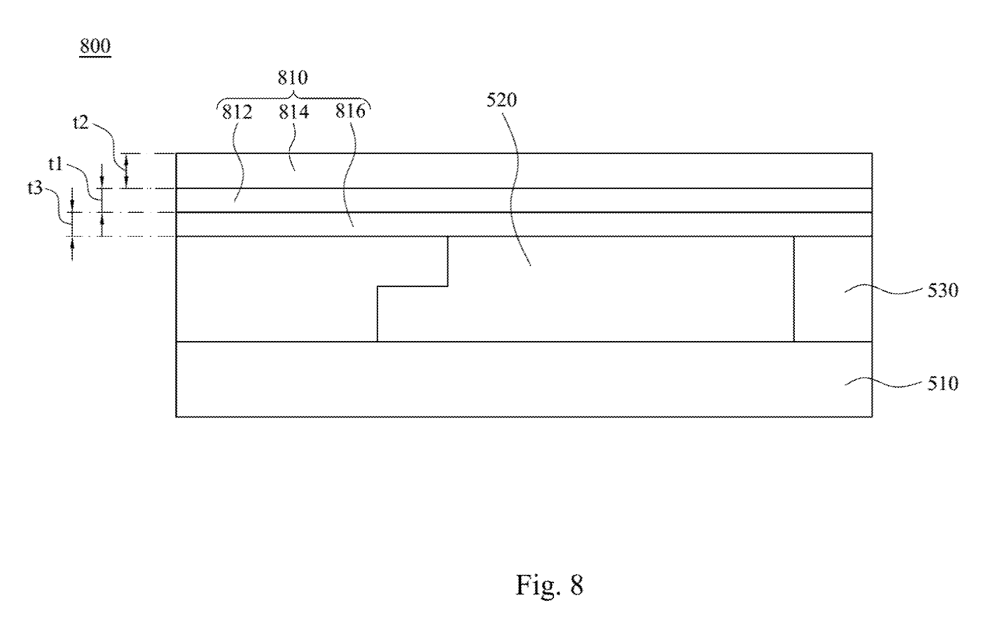

FIG. 8 is a schematic cross-sectional view at a stage of fabricating a fingerprint identification device 800 according various embodiments of the present disclosure. FIG. 8 is followed FIG. 5B. In FIG. 8, the operation of forming a protection film 810 includes forming an adhesion layer 816, forming a color-coating layer 812 and forming an optical anti-wear layer 814.

The adhesion layer 816 is formed on the sensor chip 520 and the glue layer 530. According to various embodiments of the present disclosure, a thickness (t3) of the adhesion layer 816 is in a range of 2-10 μm.

The color-coating layer 812 is formed on the adhesion layer 816. According to various embodiments of the present disclosure, the color-coating layer 812 includes a color resin layer. According to various embodiments of the present disclosure, the color-coating layer 812 has a color pattern including black, white, other colors or a combination thereof. According to various embodiments of the present disclosure, a thickness (t1) of the color-coating layer 812 is in a range of 5-30 μm.

The optical anti-wear layer 814 covers the color-coating layer 812. According to various embodiments of the present disclosure, the optical anti-wear layer 814 includes an optical hard coat layer or an optical glass layer. According to various embodiments of the present disclosure, a hardness of the optical anti-wear layer 814 is in a range of 5 H-9 H. According to various embodiments of the present disclosure, a thickness (t2) of the optical anti-wear layer 814 is in a range of 15-40 μm.

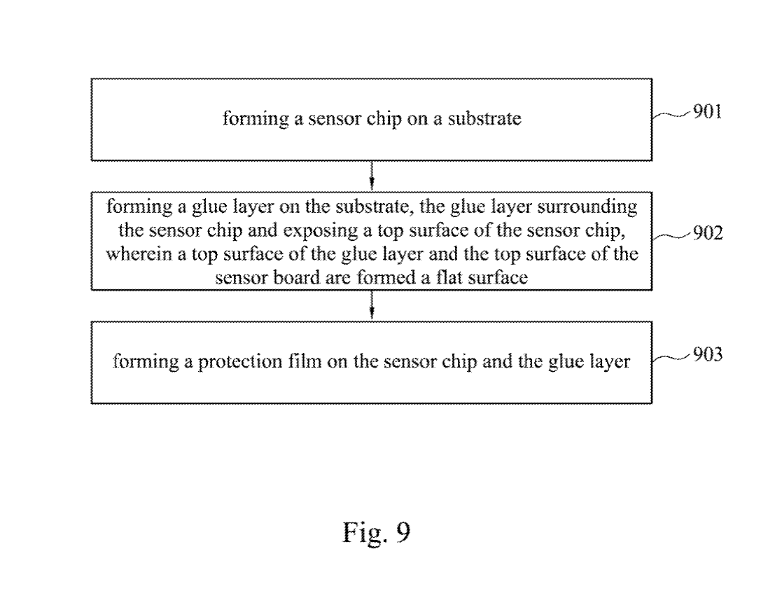

FIG. 9 is a flow chart illustrating a method for manufacturing a fingerprint identification device according various embodiments of the present disclosure. FIG. 9 includes operations 901, 902, and 903. These operations are disclosed in association with the cross-sectional views of the fingerprint identification device 500 from FIGS. 5A to 5C at various fabrication stages.

In operation 901, a sensor chip 520 is formed on a substrate 510. According to various embodiments of the present disclosure, the substrate 510 includes a circuit board or an insulating substrate. According to various embodiments of the present disclosure, the sensor chip 520 is electrically connected to the circuit board. According to various embodiments of the present disclosure, the sensor chip 520 includes a fingerprint identified chip.

In operation 902, a glue layer 530 is formed on the substrate 510. The glue layer 530 surrounds the sensor chip 520 and exposes a top surface 521 of the sensor chip 520. According to various embodiments of the present disclosure, a top surface 531 of the glue layer 530 and the top surface 521 of the sensor board 520 are formed a flat surface. According to various embodiments of the present disclosure, a material of the glue layer 530 includes an insulating composite. According to various embodiments of the present disclosure, the insulating composite includes an epoxy resin.

In operation 903, a protection film 540 is formed on the sensor chip 520 and the glue layer 530. According to various embodiments of the present disclosure a material of the protection film 540 is different from a material of the glue layer 530. According to various embodiments of the present disclosure, the protection film 540 includes an optical hard coat layer, According to various embodiments of the present disclosure, a thickness (T) of the protection film 540 is in a range of 20-50 μm.

For solving the problems in the art, the glue layer of the fingerprint identification device provided in the present disclosure merely surrounds the sensor chip and exposes the top surface of the sensor chip, so that the top surface of the glue layer is coplanar with the top surface of the sensor chip. Because the top surface of the glue layer is coplanar with the top surface of the sensor chip, and a tolerance of a thickness of the protection film adhered following may be ignored, the thickness of a structure upon the sensor chip may be efficiently regulated in a range of 20-50 μm. Additionally, the whole thickness of the fingerprint identification device may be precisely calculated to increase the applicable rate of the fingerprint identification device while the thickness of a structure upon the sensor chip may be precisely regulated.

In another aspect, the method of manufacturing the fingerprint identification device provided in the present disclosure has omitted a polishing process in a conventional manufacturing method, so as to efficiently reduce the material waste of a glue layer and the whole production time.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. A fingerprint identification device, comprising:
a substrate;
a sensor chip disposed on the substrate and having a top surface;
a glue layer disposed on the substrate, surrounding the sensor chip and exposing the top surface of the sensor chip, wherein a top surface of the glue layer is coplanar with the top surface of the sensor chip; and
a protection film covering the sensor chip and the glue layer, wherein a material of the protection film is different from a material of the glue layer.

2. The fingerprint identification device of claim 1, wherein the substrate comprises a circuit board or an insulating substrate.

3. The fingerprint identification device of claim 2, wherein the sensor chip is electrically connected to the circuit board.

4. The fingerprint identification device of claim 1, further comprising a first adhesion layer sandwiched between the sensor chip and the substrate.

5. The fingerprint identification device of claim 1, wherein the sensor chip comprises a fingerprint identified chip.

6. The fingerprint identification device of claim 1, wherein a material of the glue layer comprises an insulating composite.

7. The fingerprint identification device of claim 6, wherein the insulating composite comprises an epoxy resin.

8. , The fingerprint identification device of claim 1, wherein the protection film comprises:
a color-coating layer covering the sensor chip and the glue layer; and
an optical anti-wear layer covering the color-coating layer.

9. The fingerprint identification device of claim 7, wherein the optical anti-wear layer comprises an optical hard coat layer or an optical glass layer.

10. The fingerprint identification device of claim 7, wherein the protection film comprises a second adhesive layer sandwiched between the color-coating layer and the sensor chip and between the color-coating layer and the glue layer.

11. The fingerprint identification device of claim 1, wherein a thickness of the protection film is in a range of 20-50 μm.

12. A method for manufacturing a fingerprint identification device, comprising:
forming a sensor chip on a substrate;
forming a glue layer on the substrate, the glue layer surrounding the sensor chip and exposing a top surface of the sensor chip, wherein a top surface of the glue layer and the top surface of the sensor board are formed a flat surface; and
forming a protection film on the sensor chip and the glue layer.

13. The method of claim 12, further comprising forming a first adhesion layer between the sensor chip and the substrate.

14. The method of claim 12, wherein forming the protection film comprises:
forming a color-coating layer on the sensor chip and the glue layer; and
forming an optical anti-wear layer covering the color-coating layer.

15. The method of claim 14, wherein forming the optical anti-wear layer comprises forming an optical hard coat layer or forming an optical glass layer.

16. The method of claim 14, wherein forming the protection film further comprises forming a second adhesion layer between the color-coating layer and the sensor chip and between the color-coating layer and the glue layer.
